(19) United States
(12) Patent Application Publication
(10) Pub. No.: US 2004/0051650 A1
(43) Pub. Date: Mar. 18, 2004

(54) Two way data communication with a well logging tool using a TCP-IP system

(76) Inventors: Bryan Gonsoulin, Houston, TX (US); Terry W. Lease, Cypress, TX (US); Alanna D. Pope, Kingwood, TX (US); Larry W. Thompson, Willis, TX (US)

Correspondence Address: Patrick H. McCollum, PD Holdings (USA) Inc., Suite 1700, 363 N. Sam Houston Parkway East, Houston, TX, 77060, US

(21) Appl. No.: 10/244,571

(22) Filed: Sep. 16, 2002

(51) Int. Cl. G01V 3/00

(52) U.S. Cl. 340/853.1; 340/853.9

(57) ABSTRACT

Methods and apparatus for communicating between a MWD or LWD logging tool and a surface processor, such as a PC, using a high speed transmission control protocol-internet protocol (TCP-IP) based connection link. Logging tool sensor response is stored in memory within the tool while logging. The link is removably attached to a data port in the tool when the tool is subsequently removed from the borehole. Stored sensor response information is transferred very rapidly from tool memory as TCP-IP data packets. Transmission is two-way thereby allowing commands to be transmitted from the PC to the tool for control of the tool and the data acquisition function of the tool. The two-way data transmission function can be performed at one or more PC's remote from a drilling rig using a commercially available TCP-IP hub and the internet.

This invention is related to the measurement of parameters of materials penetrated by a well borehole, and more particularly related to a system for embedding commands and data into a TCP-IP packet for communications with and retrieval of data from a well logging device conveyed in a borehole penetrating earth formation.

### BACKGROUND OF THE INVENTION

Knowledge of physical, chemical, and elemental properties or “parameters” of earth formation is useful in a wide variety of fields including mining, hydrology, geology, and hydrocarbon production. In hydrocarbon production, formation density, porosity, lithology, permeability, and fluid type are used to determine, as examples, (a) if a formation contains hydrocarbon, (b) the amount of hydrocarbon contained in the formation, and (c) if the hydrocarbon can be produced from the formation. These parameters of interest are typically extracted from measurements of electromagnetic, acoustic and nuclear properties of the formation. As an example a measure of formation resistivity can be combined with other measurements to delineate hydrocarbon bearing formations from saline water bearing formations. As another example, a measure of acoustic velocity in a formation can be combined with other measurements to determine formation porosity. As yet another example, the measure of backscattered gamma radiation can be combined with other measurements to determined formation density. As a final example, a plurality of electromagnetic measurements can be combined to determine formation permeability. As a group, these measurements can therefore be used to determine the presence, the amount and the producibility of hydrocarbons in a formation.

Borehole instruments, or borehole “tools”, are used to measure one or more parameters of interest of formations penetrated by the borehole. Parametric measurements are usually made as a function of tool depth within the borehole, and are referred to as “logs” of the parameters. Borehole logging systems typically fall into two categories. The first category is “wireline” systems wherein the logging tool is conveyed along a borehole after the borehole has been drilled. Conveyance is provided by a wireline with one end attached to the tool and a second end attached to a winch assembly at the surface of the earth. The wireline contains one or more electrical and/or fiber optic conductors which serve as communication links between the borehole logging tool and electronic processing and power equipment at the surface of the earth. Data from response of sensors within the logging tool are telemetered to the surface using these links. In addition, commands that control tool operation are telemetered from the surface to the tool over these links. The second category is measurement-while-drilling (MWD) or logging-while-drilling (LWD) tools, wherein the logging tool is conveyed along the borehole by a drill string. Parametric measurements are made with the tool while the borehole is being drilled. Systems that measure parameters related to the borehole and the drilling operation, such as borehole direction, borehole pressure, weight on the drill bit, and the like, are usually referred to as MWD systems. Systems that measure parameters of material penetrated by the borehole are usually referred to as LWD systems. A wireline can not be used in MWD and LWD systems as a tool-surface communication link since the drill string rotates. Tool sensor response can be telemetered to the surface, and commands can be telemetered to the tool, using a variety of borehole telemetry systems. These systems including drilling fluid or drilling “mud” pulse systems, mud siren systems and electromagnetic (EM) systems.

Most present day logging tools generate large amounts of data per unit time and data per unit depth within the borehole. As an example, a six sensor resistivity tool can generate as much as 200 kilobytes of data per hour. A dual detector density tool can generate as much as 9,600 kilobytes of data per hour. For economic and operation reasons, multiple tools are often operated “in combination”, and data generated by combination tools increases as a function of the number of tools in the combination.

Wireline logging systems employing multiconductor wireline cables usually have typical bandwidth capability to transmit measured data from a tool, or from a combination of tools, to the surface in real time. LWD and MWD telemetry systems exhibit bandwidths that are orders of magnitude smaller than wireline systems. Unprocessed or “raw” sensor data, as measured by the tool's sensors, usually can not be transmitted for processing to the surface in real time using present day borehole telemetry systems. This deficiency in LWD and MWD telemetry systems is typically handled either (a) by processing raw data downhole and telemetering a lesser amount of processed data to the surface, (b) by storing raw data in downhole memory and retrieving the data when the tool is returned to the surface of the earth, or (c) by using a combination of methods (a) and (b). The, processing, of large amounts of raw data using downhole processors is often quite difficult from viewpoints of tool design, equipment reliability, tool cost, and logging operations. Processing also can require setting of processing parameters based upon characteristics of the raw data. Often, these characteristics can be determined only by inspecting the raw data, thereby introducing serious problems in the downhole data processing methodology.

In MWD and LWD logging, the storing of raw data downhole and subsequent retrieval and processing of the data at the surface of the earth is the only effective means for data bandwidths generated by present day tools and tool combinations. As discussed previously, it is also necessary to supply commands to the tool. The system must, therefore, not only retrieve data from the tool but also supply data to the tool.

Current systems for communicating with a LWD or MWD logging tool, once retrieved to the surface of the earth, require a communication link between the tool and a surface processor. The surface processor extracts and receives downhole data measured by the tool, and also generates command data supplied to the tool. Two-way communication between the tool and the surface processor is typically established on the drilling rig floor. It is operationally and economically advantageous to make the time duration of the communication process as short as possible. Operationally, the physical integrity of the borehole is at risk with the drill string out of the borehole and with no drilling mud circulation. Economically, drilling rig time is very expensive. The borehole is not being advanced while the drill string is removed from the borehole, and the tool and surface processor are communicating at the surface over a two way communications link. The surface processor can be a personal computer (PC) or any other suitable processing means for receiving and mathematically manipulating data from the tool, and for generating commands to be transferred to the tool. For purposes of this disclosure, a PC will be used as a surface processor, with the understanding that alternate surface processors are available.

Serial links between the tool and the PC, comprising electrical conductors, have been used, but these links are relatively slow and require the PC to be physically near the tool unless additional relay type hardware is used. Regarding speed, as much as three hours can be required to transfer 32,000 kilobytes of data from the tool memory to the PC. For purposes of comparison, this is the amount of data generated by a typical six sensor resistivity tool over 160 hours of logging. Nuclear tools typically generate considerably more data per unit time of logging. Parallel communication links have been used. The parallel electrical conductor links are much faster than traditional serial communication links, but the distance that the data can be transmitted is further reduced. Parallel links are still relatively slow requiring of the order of 1 hour to transfer 32,000 kilobytes of data from the tool memory to the PC. Fiber optic links provide a much greater data throughput. Fiber optic links are, however, difficult to maintain in the harsh environment of a drilling rig. Fiber optics cables are easily broken and very difficult to repair in a field environment. Wireless radio frequency (RF) links have been used, but RF interferences or “noise” generated by the drilling rig makes this type of link difficult to implement.

### BRIEF DESCRIPTION OF THE DRAWINGS

In the accompanying drawings:

FIG. 1 illustrates conceptually a LWD or MWD tool linked with a surface processor so that sensor response data can be extracted from the tool and commands can be sent to the tool using a TCP-IP based system;

FIG. 2 illustrates conceptually a LWD or MWD tool linked with a plurality of surface processors through the Internet so that sensor response data can be extracted from the tool and commands can be sent to the tool from any or all processors;

FIG. 3 illustrates conceptually a combination tool comprising multiple LWD or MWD tools, wherein the combination tool is linked with a surface processor so that sensor response data can be extracted from each tool and commands can be sent to each tool through a dedicated data port; and

FIG. 4 illustrates conceptually a combination tool comprising multiple LWD or MWD tools, wherein the combination tool is linked with a surface processor so that sensor response data can be extracted from each tool and commands can be sent to each tool through a common data port.

### EMBODIMENTS

The present invention provides methods and apparatus for communicating between a MWD or LWD logging tool and a surface processor, such as a PC, using a high speed Transmission Control Protocol-Internet Protocol based connection link referred to as TCP-IP. Discussions of TCP/IP can be found in the books Internetworking with TCP/IP, Volume 1 (ISBN0132169878), Volume 2 (ISBN0131255274) and Volume 3 (ISBN013260969X) by Douglas Corner, published by Prentice-Hall, TCP/IP illustrated, volume 1 (ISBN0201633469), volume 2 (ISBN020163354X) and volume 3 (ISBN0201634653) by Richard Stevens, published by Addison-Wesley, TCP/IP Architecture, Protocols, and Implementation with IPV6 and IP Security (ISBN0070213895) by Sidnie Feit, published by McGraw-Hill, and Internet Core Protocols (ISBN1565925726) by Eric A Hall, published by O'Reilly.

Communication occurs with the tool removed from the borehole. The majority of present day PCs are equipped to handle TCP-IP data packets. The data packets can be transferred from tool memory to the PC very rapidly thereby minimizing operational and economic problems of drilling downtime previously discussed. Transmission is two-way thereby allowing commands to be transmitted from the PC to the tool for control of the tool and the data acquisition function of the tool. TCP-IP transmission protocol is both robust and reliable thereby making the system suitable for use in the harsh drilling rig environment. The two-way data transmission function can be performed at one or more PC's remote from the drilling rig using a commercially available TCP-IP hub and the internet.

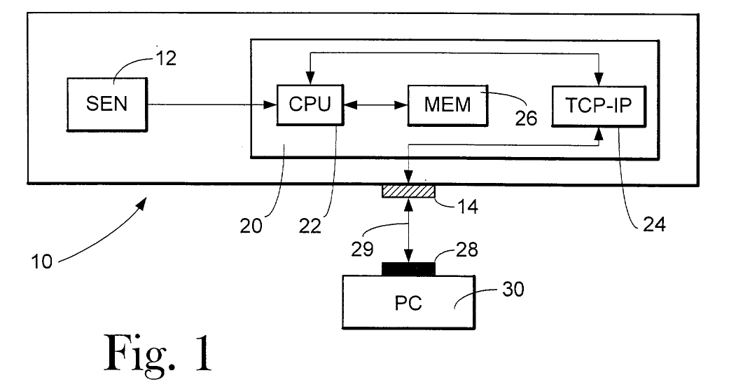

FIG. 1 is a conceptual illustration of a LWD or MWD tool 10 that contains one or more sensors. Only one sensor 12 is shown for purposes of clarity. The tool 10 contains circuitry 20 that is preferably in the form of a circuit board. The circuit board comprises a central processing unit (CPU) 22, a memory 26, and a TCP-IP converter 24. Data from the sensor 20 pass through the CPU 22 and are stored in the memory 26 for subsequent retrieval when the tool 10 is returned to the surface of the earth. In the data retrieval process at the surface of the earth, data are withdrawn from the memory 26 under the control of the CPU 22 and transferred to the TCP-IP converter 24, which is also under the control of the CPU. The TCP-IP converter 24 is designed to pass data, formatted in TCP-IP data packets, between the memory 26 (via the CPU 22) and a TCP-IP network. As shown in FIG. 1, TCP-IP packets pass from the TCP-IP converter 24 and through a tool data port 14 over a suitable link 29 to a local area network (LAN) port 28, such as an ethernet port, of a processor such as a PC 30. One end of the link 29 is removably attached to the data port 14 with the tool 10 at the surface. Upon completion of transfer of data from the tool and command information to the tool, the link 29 is disconnected from the data port 14 prior to resumption of the drilling operation. Other embodiments will be illustrated in subsequent sections of this disclosure.

Still referring to FIG. 1, the CPU 22 is preferably interfaced to the TCP-IP converter 24 through either an eight bit parallel interface or a serial peripheral interface (SPI). Only one of these interfaces may be active at a given time. The active interface is preferably selected by a single control line on a IP2022 microprocessor contained within the TCP-IP converter 24. Both of the interfaces provide the same functionality to the CPU 22, which includes the configuration of the TCP-IP converter, the sending of data, and the receiving of data by the tool 10. The TCP-IP converter preferably connects to the PC 30 using a full duplex 10Base-T Ethernet connection that can reach network speeds above 8 megabits per second (Mb/s). The PC 30, and any other network devices operationally connected to the tool 10 through the TCP-IP converter 24 can, therefore, receive data from the CPU 22 and the memory 26 which passes data to the CPU.

Still referring to FIG. 1, it is desirable and often necessary to send commands to the tool 10 to control tool parameters such as data acquisition functions and the operation of the tool. Tool parameters can include sensor response range, sensor timing, voltages to various tool circuits, sensor data sampling rate, and the like. Commands are generated in the PC 30 or alternately in any other suitable network device. These command data are formatted as TCP-IP packets by the PC 30 or other network devices, and pass from the LAN port 28 over the link 29 to the TCP-IP converter 24 through the tool data port 14. The PC 30, and any other network devices operationally connected to the tool 10 through the TCP-IP converter 24, can, therefore, send command information to the CPU 22 and the memory 26 which receives information through the CPU.

To summarize, information can flow to and from the tool 10 from and to the PC 30 in the form of TCP-IP data packets. Information flowing from the tool to the PC is typically sensor response data, which can be subsequently processed by the PC to obtain measures of properties of interest. Information flowing from the PC to the tool is typically command information, which controls sensor data gathering and the overall operation of the tool.

The area of the TCP-IP converter circuit is about two square inches. The circuit board 20 requires about 3 Volts, and is designed to operate at a maximum temperature of about 165 degrees centigrade. Preferably, the link 29 comprises electrical conductors. In principle, a link comprising optical fibers or a RF link can be used, but with operational disadvantages discussed previously. Links comprising electrical conductors and optical fibers are physically connected to the tool and the PC. A RF link requires no physical link connection. The term “operational” connection includes all communication link connections between the tool and the PC including physical connections (e.g. electrical and optical fiber links) and non-physical connections (e.g. RF links).

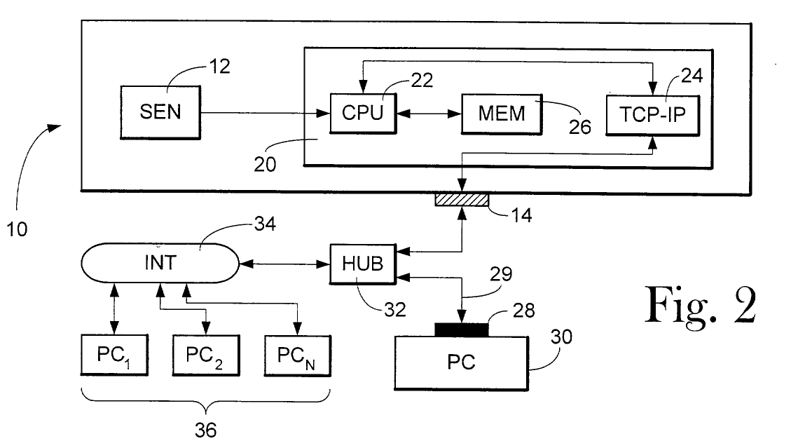

The network can comprise the internet since TCP-IP packets are compatible with internet data transmission. This allows other network devices, such as one or more PC remote from the drilling rig, to be operationally connected the system through the internet. This embodiment of the invention is shown conceptually in FIG. 2.

FIG. 2 again illustrates conceptually a tool 10 comprising a sensor 12 and a circuit board 20 comprising a CPU 22, a memory 26 and a TCP-IP converter 24. A TCP-IP compatible hub 32 is shown connected in series with the link 29 connecting to the LAN port 28 of the PC 30. The hub interfaces with the Internet, which is illustrated conceptually at 34. Any number of additional PCᵢs (i=1, 2, . . . , N), denoted as a group at 36, can be operationally connected to the tool 10 through the Internet 34 and the hub 32. This embodiment allows data to be received from the tool 10, and commands to be sent to the tool, from any location at which the Internet 34 can be accessed. Such a remote location might be a client's office. Furthermore, data can be received and commands can be sent simultaneously from the drilling rig site and from locations remote from the drilling rig site.

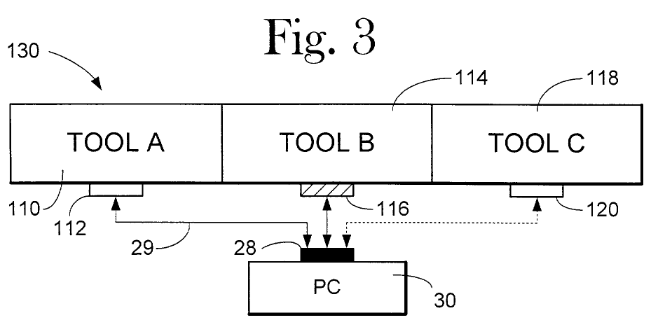

As mentioned previously, more than one type of MWD or LWD tools are run in combination for a variety of reasons including measurement correlation, and reduction in drilling rig time devoted solely to MWD and LWD measurements. A combination tool 130 is illustrated conceptually in FIG. 3. As illustrated, the combination tool comprises a tool “A” at 110, a tool “B” at 114, and a tool “C” at 118. Each tool comprises at least one sensor, and a circuit board comprising a CPU, a memory and a TCP-IP converter as illustrated with tool 10 in FIGS. 1 and 2. The combination can contain as few as two tools, or as many tools as can be operated within the parameters of the drilling operation. Tools can be all LWD tools, all MWD tools, or a combination of LWD and MWD tools. As an example of the latter combination, tool A can be a directional tool, tool B can be a resistivity tool, and tool C can be a nuclear tool.

Still referring to FIG. 3, data stored in memory of each tool are retrieved when the combination tool 110 is returned to the surface of the earth. FIG. 3 illustrates the combination tool embodied with each tool in the combination having its own data port. That is, tool 110 has a data port 112, tool 114 has a data port 116, and tool 118 has a data port 120. With this configuration, data are received and commands are sent to the tools A, B, C, etc sequentially. As an example, the link 29 is first operationally connected to the data port 112, data are received by the PC 30 from tool A, and commands are sent from the PC to tool A. Sequentially, the link 29 (shown as a broken line to indicate a sequential connection) is operationally connected to the data port 116 and data are exchanged between the PC 30 and tool B. Again sequentially, the link 29 (shown as a broken line) is operationally connected to the data port 120 and data are exchanged between the PC 30 and tool C. This process is repeated in sequence for every tool in the combination tool 130.

Referring to both FIGS. 2 and 3, it should be understood that a hub 32 can be connected in series with the link 29, and data exchange can be performed between each tool in the combination tool 130 and any or all of the remote PCᵢs 36 through the internet 34 (as illustrated and discussed previously).

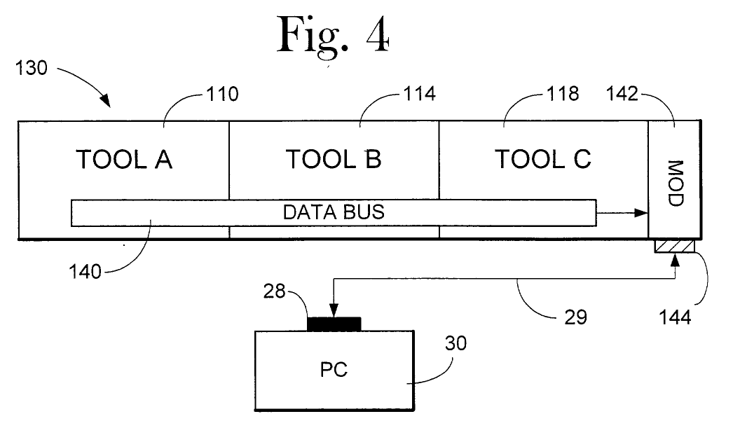

FIG. 4 illustrates conceptually yet another embodiment of the invention. A combination tool 130 is again show comprising three tools A, B and C denoted at 110, 114 and 118, respectively. In this embodiment, a TCP-IP compatible data bus 140 connects the TCP-IP converter in each tool A, B and C to a data exchange module 142 comprising a single combination tool data port 144. Again, a link 29 operationally connects the combination tool data port 144 with the PC 30 through the LAN port 28. Under the control of the PC 30, the data exchange module 142 directs data exchange between each tool A, B, C, etc in the combination tool through the single combination tool data port 144. Data exchange can be serial or multiplexed, as determined by commands from the PC to the data exchange module 142.

Referring to both FIGS. 2 and 4, it should be understood that a hub 32 can again be connected in series with the link 29 to the combination data port 144, and data exchange can be performed between each tool in the combination tool 130 and any or all of remote PCᵢs 36 through the internet 34 (as discussed and illustrated previously).

One skilled in the art will appreciate that the present invention can be practiced by other that the described embodiments, which are presented for purposes of illustration and not limitation, and the present invention is limited only by the claims that follow.

What is claimed is:

1. A logging tool comprising:
(a) a memory; and
(b) a TCP-IP converter cooperating with said memory to transfer information into and out of said memory as TCP-IP data packets.

2. The apparatus of claim 1 further comprising a data port connected to said TCP-IP converter and through which said TCP-IP data packets are passed between said tool and a processor via a link removably and operationally connecting said data port and said processor.

3. The apparatus of claim 2 further comprising a CPU cooperating with said TCP-IP converter and said memory to control said transfer of information between said TCP-IP converter and said memory.

4. The apparatus of claim 3 wherein:
(a) said processor is a PC; and
(b) said link operationally connects to said PC via a LAN data port in said PC.

5. The apparatus of claim 3 further comprising a sensor cooperating with said CPU wherein said information comprises response of said sensor.

6. The apparatus of claim 4 wherein said information comprises a command entered into said PC.

7. A logging system comprising:
(a) a tool comprising
(i) a memory,
(ii) a TCP-IP converter cooperating with said memory to transfer information into and out of said memory as TCP-IP data packets,
(iii) a CPU cooperating with said TCP-IP converter and said memory, and
(iv) a data port connected to said TCP-IP converter and through which said TCP-IP data packets are passed;
(b) a PC comprising a LAN port; and
(c) a link with a first end removably and operationally connected to said data port and a second end operationally connected to said LAN port; wherein
(d) information is transferred between said PC and said tool as TCP-IP data packets.

8. The system of claim 7 further comprising:
(a) a hub in series with said link and connected to an internet; and
(b) a plurality of PCs comprising said PC and at least one remote PC connected to said tool through said internet and said hub; wherein
(c) said information is transferred between said tool and at least one of said plurality of PCs.

9. The system of claim 7 further comprising a sensor cooperating with said CPU wherein said information comprises response data from said sensor.

10. The system of claim 8 wherein said information comprises a command entered into at least one of said plurality of PCs.

11. A logging system comprising:
(a) a combination tool comprising at least two tools, wherein each of said at least two tools comprises
(i) a memory,
(ii) a TCP-IP converter cooperating with said memory to transfer information into and out of said memory as TCP-IP data packets,
(iii) a CPU cooperating with said TCP-IP converter and said memory, and
(iv) a data port connected to said TCP-IP converter and through which said TCP-IP data packets are passed;
(b) a PC comprising a LAN port; and
(c) a link with a first end removably and operationally connected to said data port of each said tool and with a second end operationally connected to said LAN port; wherein
(d) information is transferred between said PC and each said tool as TCP-IP data packets.

12. The system of claim 11 further comprising:
(a) a hub in series with said link and connected to an internet; and
(b) a plurality of PCs comprising said PC and at least one remote PC connected to said combination tool through said internet and said hub; wherein
(c) said information is transferred between said at least one tool of said combination tool and at least one PC of said plurality of PCs.

13. The system of claim 11 wherein each said tool further comprising a sensor and said information comprises response data from at least one said sensor.

14. The system of claim 12 wherein said information is entered into at least one of said plurality of PCs and comprises a command for at least one said tool of said combination tool.

15. A logging system comprising:
(a) a combination tool comprising at least two tools, wherein each of said at least two tools comprises
(i) a memory,
(ii) a TCP-IP converter cooperating with said memory to transfer information into and out of said memory as TCP-IP data packets, and
(iii) a CPU cooperating with said TCP-IP converter and said memory;
(b) a data bus connecting said TCP-IP converter in each said tool to a data exchange module comprising a combination tool data port;
(c) a PC comprising a LAN port; and
(d) a link with a first end removably and operationally connected to said combination tool data port and with a second end operationally connected to said LAN port; wherein
(e) information is transferred between said PC and each said tool as TCP-IP data packets.

16. The system of claim 15 further comprising:
(a) a hub in series with said link and connected to an internet; and
(b) a plurality of PCs comprising said PC and at least one remote PC connected to said combination tool through said internet and said hub; wherein
(c) said information is transferred between at least one said tool of said combination tool and at least one PC of said plurality of PCs.

17. The system of claim 15 wherein each said tool further comprising a sensor and said information comprises response data from at least one of said sensor.

18. The system of claim 16 wherein said information is entered into at least one of said plurality of PCs and comprises a command for at least one said tool of said combination tool.

19. A method for measuring a parameter in a borehole while drilling the borehole, the method comprising:
(a) providing a tool comprising a memory, wherein said tool is removably conveyable in said borehole;
(b) disposing within said tool a TCP-IP converter that cooperates with said memory;
(c) measuring with a sensor disposed within said tool sensor response data indicative of said parameter;
(d) storing said sensor response data within said memory during drilling of said borehole;
(e) using said TCP-IP converter to convert said tool response data into TCP-IP data packets; and
(f) transferring said TCP-IP data packets from said tool upon cessation of said drilling of said borehole.

20. The method of claim 19 further comprising transferring said TCP-IP data packets through a data port to a processor via a link removably and operationally connecting said data port and said processor.

21. The method of claim 20 further comprising:
(a) inputting a tool command into said processor; and
(b) transferring said command as TCP-IP data packets from said processor to said tool via said link connecting said processor and said tool.

22. The method of claim 21 wherein:
(a) said processor is a PC; and
(b) said link operationally connects to said PC via a LAN data port in said PC.

23. A method for logging a borehole comprising:
(a) conveying a tool in a borehole, wherein said tool comprises
(i) a memory,
(ii) a TCP-IP converter cooperating with said memory,
(iii) a CPU cooperating with said TCP-IP converter and said memory,
(iv) a sensor cooperating with said CPU, and
(v) a data port connected to said TCP-IP converter;
(b) transferring information into and out of said memory as TCP-IP data packets; and
(c) passing said TCP-IP data packets between said tool and a PC via a link connecting said data port and a LAN port of said PC; wherein
(d) said link is removably connected to said data port when said tool is removed from said borehole.

24. The method of claim 23 further comprising:
(a) disposing a hub in series with said link;
(b) connected said hub to an internet;
(c) connecting a plurality of PCs comprising said PC and at least one remote PC connected to said tool through said internet and said hub; and
(d) transferring said information between said tool and at least one of said plurality of PCs.

25. The method of claim 24 wherein said information transferred from said tool to said at least one PC comprises response from said sensor indicative of material penetrated by said borehole.

26 The method of claim 24 wherein said information transferred from said at least one PC to said tool comprises a command controlling operation of said tool.

27. A method for logging a borehole comprising:
(a) conveying a combination tool in said borehole, wherein said combination tool comprises at least two tools and wherein each of said at least two tools comprises
(i) a memory,
(ii) a TCP-IP converter cooperating with said memory,
(iii) a CPU cooperating with said TCP-IP converter and said memory,
(iv) a sensor cooperating with said CPU, and
(v) a data port connected to said TCP-IP converter;
(b) transferring information into and out of each said memory of each said tool as TCP-IP data packets; and
(c) passing said TCP-IP data packets between each said tool and a PC via a link sequentially connecting each said data port and a LAN port of said PC; wherein
(d) said link is removably attached to each said data port when said tool is removed from said borehole.

28. The method of claim 27 further comprising:
(a) disposing a hub in series with said link;
(b) connected said hub to an internet;
(c) connecting a plurality of PCs comprising said PC and at least one remote PC connected to said tool through said internet and said hub; and
(d) transferring said information between at least one of said tools and at least one of said plurality of PCs.

29. The method of claim 28 wherein said information transferred from at least one said tool to said at least one PC comprises response of at least one said sensor indicative of material penetrated by said borehole.

30. The method of claim 28 wherein said information transferred from said at least one PC to said at least one tool comprises a command controlling operation of said at least one tool.

31. A method for logging a borehole comprising:
(a) conveying a combination tool in said borehole, wherein said combination tool comprises
(i) at least two tools and wherein each of said at least two tools comprises
a memory,
a TCP-IP converter cooperating with said memory,
a CPU cooperating with said TCP-IP converter and said memory, and
a sensor cooperating with said CPU, and
(ii) a data bus connecting said each said TCP-IP converter in each said tool to a data exchange module comprising a combination tool data port;
(b) transferring information into and out of each said memory of each said tool as TCP-IP data packets; and
(c) passing said TCP-IP data packets between each said tool and a PC via said data bus and a link connecting said combination tool data port and a LAN port of said PC; wherein
(d) said link is removably attached to said combination tool data port when said combination tool is removed from said borehole.

32. The method of claim 31 further comprising:
(a) disposing a hub in series with said link;
(b) connected said hub to an internet;
(c) connecting a plurality of PCs comprising said PC and at least one remote PC connected to said tool through said internet and said hub; and
(d) transferring said information between at least one of said tools and at least one of said plurality of PCs.

33. The method of claim 32 wherein said information transferred from said at least one tool to said at least one PC comprises sensor response indicative of material penetrated by said borehole.

34 The method of claim 32 wherein said information transferred from said at least one PC to said at least one tool comprises a command controlling operation of at least one said tool.
